(19) United States
(12) Patent Application Publication
(10) Pub. No.: US 2025/0202177 A1
(43) Pub. Date: Jun. 19, 2025

(54) CHARGING OR DISCHARGING DEVICE

(71) Applicant: SK On Co., Ltd., Seoul (KR)

(72) Inventors: Chang Mook HWANG, Daejeon (KR); Hyun Ji KIM, Daejeon (KR); Gyeong Min RYU, Daejeon (KR)

(21) Appl. No.: 18/979,600

(22) Filed: Dec. 13, 2024

(30) Foreign Application Priority Data
Dec. 14, 2023 (KR) 10-2023-0181607

(51) Int. Cl. H01R 29/00; H01M 4/04

(52) U.S. Cl. CPC H01R 29/00; H01M 4/0447

(57) ABSTRACT

A charging or discharging device of the present disclosure includes: a plurality of external terminals including a first external terminal and a second external terminal for charging or discharging a battery cell; a first connecting terminal electrically connected to the first external terminal; a busbar electrically connected to the second external terminal; a second connecting terminal spaced apart from the first connecting terminal in a first horizontal direction and electrically connected to the second external terminal; and a third connecting terminal spaced apart from the first connecting terminal in a second horizontal direction perpendicular to the first horizontal direction and electrically connected to the second external terminal through the busbar.

### CROSS-REFERENCE TO RELATED PATENT APPLICATION

The present application claims priority under 35 U.S.C. § 119 (a) to Korean patent application number 10-2023-0181607 filed on Dec. 14, 2023 in the Korean Intellectual Property Office, the entire disclosure of which is incorporated by reference herein.

### BACKGROUND OF THE INVENTION

### 1. Field

The present disclosure relates to a battery, and specifically, to a charging or discharging device.

### 2. Description of the Related Art

Batteries undergo a formation process during the manufacturing process. The formation process is a process in which charging or discharging of batteries are repeated several times to impart electrical characteristics to the batteries. The formation process is carried out by a charging or discharging device. Battery cells may be manufactured in a variety of specifications.

### SUMMARY OF THE INVENTION

An object of the present disclosure is to provide a charging or discharging device compatible with battery cells of various specifications.

The present disclosure can be applied in the field of green technologies, such solar power generation and wind power generation. In addition, the present disclosure can be directly or indirectly applied in eco-friendly devices such as electric vehicles and hybrid vehicles for preventing air pollution and climate change by suppressing greenhouse gas emissions.

A charging or discharging device according to an embodiment of the present disclosure includes: a plurality of external terminals including a first external terminal and a second external terminal for charging or discharging a battery cell: a first connecting terminal electrically connected to the first external terminal; a busbar electrically connected to the second external terminal: a second connecting terminal spaced apart from the first connecting terminal in a first horizontal direction and electrically connected to the second external terminal; and a third connecting terminal spaced apart from the first connecting terminal in a second horizontal direction perpendicular to the first horizontal direction and electrically connected to the second external terminal through the busbar.

In an embodiment, the first connecting terminal may be electrically connected to a first electrode tab of the battery cell, and one of the second connecting terminal or the third connecting terminal may be electrically connected to a second electrode tab of the battery cell.

In an embodiment, the second connecting terminal may be electrically connected to the second electrode tab when the first electrode tab and the second electrode tab protrude in a same direction.

In an embodiment, the third connecting terminal may be electrically connected to the second electrode tab when the first electrode tab and the second electrode tab protrude in opposite directions.

In an embodiment, the charging or discharging device may further include a rail disposed under the third connecting terminal, and the third connecting terminal may be movable along the second horizontal direction through the rail.

In an embodiment, the distance between the third connecting terminal and the first connecting terminal may be longer than the length of a main body of the battery cell.

In an embodiment, the charging or discharging device may further include a base plate disposed under the plurality of external terminals, the first connecting terminal, the second connecting terminal, and the third connecting terminal, and at least a part of the busbar may be disposed under the base plate.

In an embodiment, the base plate may include an opening formed so that at least a part of an upper portion of the busbar is exposed, and the opening may be positioned in an area between the third connecting terminal and the first connecting terminal.

In an embodiment, the charging or discharging device may further include a busbar cover which is disposed between the first connecting terminal and the third connecting terminal and on which the main body of the battery cell is mounted.

In an embodiment, the busbar cover may include: a cover member of which length is adjusted as the third connecting terminal moves along the second horizontal direction; and an accommodating portion in which at least a part of the cover member is accommodated.

In an embodiment, the accommodating portion may include: a rotating shaft winding or unwinding the cover member: a latch coupled to the rotating shaft: a lever preventing rotation of the latch in a direction in which the cover member is wound, either clockwise or counterclockwise; and a switch separating the lever from the latch so that the cover member is wound.

In an embodiment, the accommodating portion may include: a spring member coupled to one end of the cover member and winding the cover member by a restoring force when the cover member is unwound: a lever being in contact with the cover member and preventing the winding of the cover member; and a switch separating the lever from the cover member so that the cover member is wound by the spring member.

In an embodiment, at least one of the first connecting terminal or the second connecting terminal may include: a pressurizing portion disposed at an upper portion of a corresponding electrode tab among a first electrode tab and a second electrode tab of the battery cell protruding in a same direction: a connecting portion disposed at a lower portion of the corresponding electrode tab and electrically connected to a corresponding external terminal among the first external terminal and the second external terminal; and an adjusting portion adjusting the height of the pressurizing portion so that the pressurizing portion pressurizes the upper portion of the corresponding electrode tab so that the corresponding electrode tab is electrically connected to the connecting portion.

In an embodiment, the third connecting terminal may include: a pressurizing portion disposed at an upper portion of a second electrode tab among a first electrode tab and a second electrode tab of the battery cell protruding in opposite directions: a connecting portion disposed at a lower portion of the second electrode tab; and an adjusting portion adjusting the height of the pressurizing portion so that the pressurizing portion pressurizes the upper portion of the second electrode tab to electrically connect the second electrode tab to the busbar through the connecting portion.

In an embodiment, the third connecting terminal may further include an elastic member connected between the pressurizing portion and the connecting portion.

In an embodiment, the connecting portion may be in one of a state of being spaced apart from the busbar or a state of being in contact with the busbar depending on adjustment by the adjusting portion.

An embodiment of the present disclosure can provide a charging or discharging device that is compatible with battery cells of various specifications.

An embodiment of the present disclosure can provide a charging or discharging device capable of protecting a busbar.

### BRIEF DESCRIPTION OF THE DRAWINGS

FIG. 1 shows a block diagram for explaining a charging or discharging device according to an embodiment.

FIG. 2 shows a diagram for explaining a charging or discharging device according to an embodiment.

FIG. 3 shows a diagram for explaining a state in which a busbar cover is separated from the charging or discharging device of FIG. 2.

FIG. 4 shows a diagram for explaining a cross-section of a charging or discharging device according to an embodiment.

FIG. 5 shows a diagram for explaining a state in which a battery cell of a first type is coupled to a charging or discharging device according to an embodiment.

FIG. 6 shows a diagram for explaining a state in which a third connecting terminal has moved according to an embodiment.

FIG. 7 shows a diagram for explaining a state in which a battery cell of a first type is coupled to a charging or discharging device according to an embodiment.

FIG. 8 shows a diagram for explaining a state in which a battery cell of a second type is coupled to a charging or discharging device according to an embodiment.

FIG. 9 shows a diagram for explaining a connecting terminal of a charging or discharging device according to an embodiment.

FIG. 10 shows a diagram for explaining a connecting terminal of a charging or discharging device according to an embodiment.

FIG. 11 shows a drawing for explaining a busbar cover of a charging or discharging device according to an embodiment.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

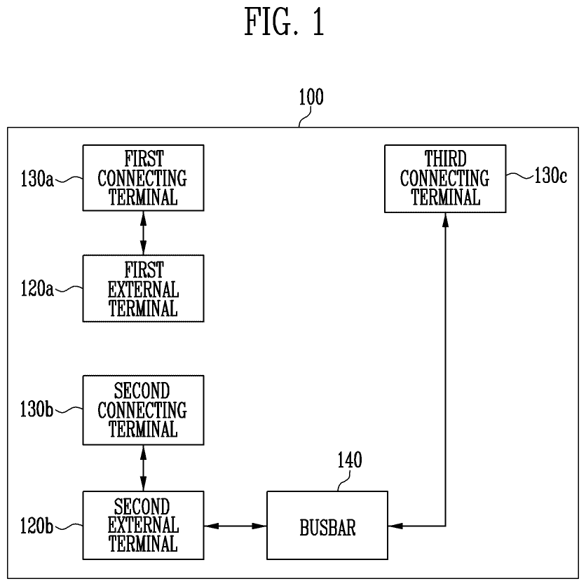

FIG. 1 shows a block diagram for explaining a charging or discharging device according to an embodiment.

Referring to FIG. 1, a charging or discharging device 100 according to an embodiment may charge or discharge a battery cell. For example, a charging or discharging device 100 may be a device used in a formation process for activating or evaluating electrical characteristics of a battery cell during a manufacturing process of the battery cell.

A battery cell may be a secondary battery capable of charging or discharging electric energy multiple times. For example, a secondary battery may be one of various types, such as a lithium ion battery, a lithium polymer battery, a nickel metal hydride battery, a nickel cadmium battery, a sodium battery, and the like. A battery cell may include a main body and a pair of electrode tabs. A pair of electrode tabs may include a first electrode tab and a second electrode tab. A first electrode tab and a second electrode tab may be electrode tabs having different polarities. For example, a first electrode tab may be a cathode tab, and a second electrode tab may be an anode tab. For another example, a first electrode tab may be an anode tab, and the second electrode tab may be a cathode tab.

In an embodiment, a charging or discharging device 100 may include a plurality of external terminals 120a and 120b, a plurality of connecting terminals 130a to 130c, and a busbar 140. In an embodiment, a charging or discharging device 100 may include a charging or discharging module. A charging or discharging module may be electrically connected to a plurality of external terminals 120a and 120b. A charging or discharging module may charge or discharge a battery cell electrically connected through a plurality of external terminals 120a and 120b. For example, a charging or discharging module may provide an alternating current (or direct current) for charging or discharging a battery cell through a plurality of external terminals 120a and 120b.

A plurality of external terminals 120a and 120b may include a first external terminal 120a and a second external terminal 120b for charging or discharging a battery cell. Each of a plurality of external terminals 120a and 120b may include a conductive material. For example, a conductive material may be one material of copper, gold, and silver, or a combination thereof. However, this is only an example, and a conductive material may be any material having an electrical conductivity of a certain value or higher, and may be implemented using various materials.

The plurality of connecting terminals 130a to 130c may include a first connecting terminal 130a, a second connecting terminal 130b, and a third connecting terminal 130c. A first connecting terminal 130a may be electrically connected to the first external terminal 120a. A second connecting terminal 130b may be electrically connected to a second external terminal (120b). The third connecting terminal 130c may be electrically connected to a busbar 140. Each of a plurality of connecting terminals 130a to 130c may include a conductive material.

A first connecting terminal 130a may be electrically connected to a first electrode tab of a battery cell. In this case, the first electrode tab of the battery cell may be electrically connected to a first external terminal 120a through the first connecting terminal 130a.

One of a second connecting terminal 130b or a third connecting terminal 130c may be electrically connected to a second electrode tab of a battery cell. In other words, a second electrode tab of a battery cell may be selectively connected to one of a second connecting terminal 130b or a third connecting terminal 130c. In this case, the second electrode tab of the battery cell may be electrically connected to a second external terminal 120b through one of the second connecting terminal 130b or the third connecting terminal 130c.

A busbar 140 may be electrically connected to a second external terminal 120b. In other words, a third connecting terminal 130c may be electrically connected to a second external terminal 120b through a busbar 140. For example, a second electrode tab of a battery cell may be electrically connected to a second external terminal 120b through a third connecting terminal 130c and a busbar 140. A busbar 140 may include a conductive material.

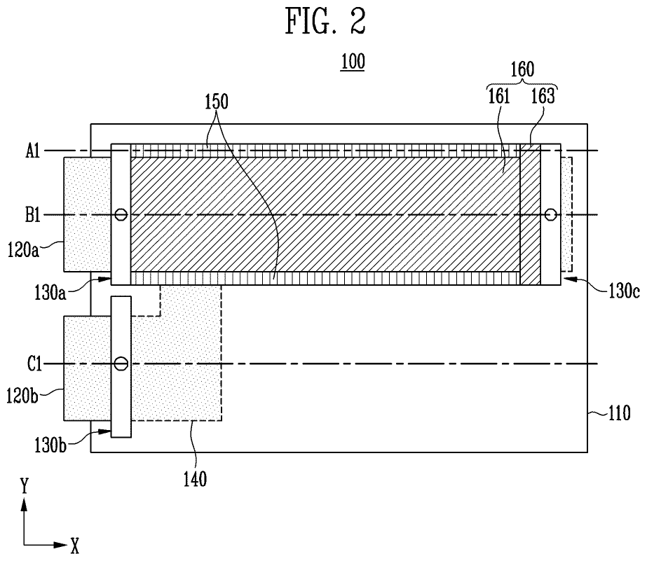

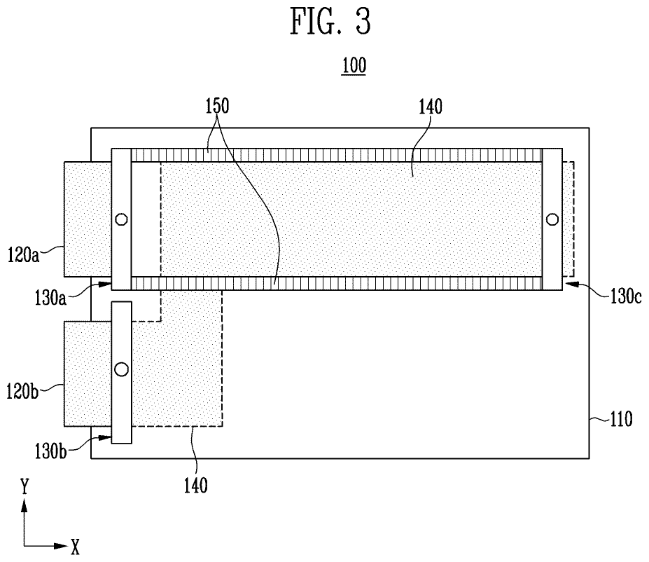

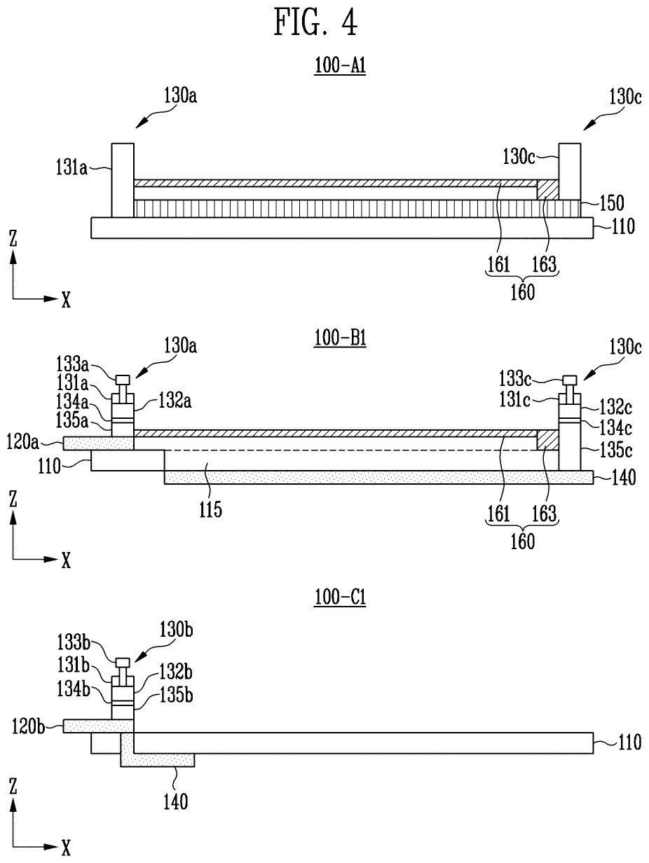

FIG. 2 shows a diagram for explaining a charging or discharging device according to an embodiment. FIG. 3 shows a diagram for explaining a state in which a busbar cover is separated from the charging or discharging device of FIG. 2. FIG. 4 shows a diagram for explaining a cross-section of a charging or discharging device according to an embodiment. The 100-A1, 100-B1, and 100-C1 in FIG. 4 represent cross-sections of the A1, B1, and C1 portions of FIG. 2, respectively.

Referring to FIGS. 2 to 4, a charging or discharging device 100 according to an embodiment may include a plurality of external terminals 120a and 120b, a plurality of connecting terminals 130a to 130c, and a busbar 140. In an embodiment, a charging or discharging device 100 may further include at least one of a base plate 110, a rail 150, and a busbar cover 160.

A base plate 110 may fix each component of a charging or discharging device 100 and support each component. In an embodiment, a base plate 110 may include an insulating material. For example, the insulating material may be a material having electrically insulating properties and having an electrical conductivity below a reference value.

A plurality of external terminals 120a and 120b and a plurality of connecting terminals 130a to 130c may be disposed on the top of a base plate 110. In other words, a base plate 110 may be disclosed under a plurality of external terminals 120a and 120b and a plurality of connecting terminals 130a to 130c. In an embodiment, at least one of a rail 150 and a busbar cover 160 may be disposed on the top of a base plate 110.

An first external terminal 120a and a second external terminal 120b may be disposed on the top of a base plate 110. In an embodiment, a first external terminal 120a and a second external terminal 120b may be spaced apart from each other in a first horizontal direction (e.g., Y-axis direction). In an embodiment, a first external terminal 120a and a second external terminal 120b may protrude from an end of a base plate 110 along a second horizontal direction (e.g., X-axis direction). Accordingly, each of a first external terminal 120a and a second external terminal 120b may be easily connected to a charge and discharge module. A second horizontal direction (e.g., X-axis direction) may be a horizontal direction perpendicular to a first horizontal direction (e.g., Y-axis direction). A horizontal direction may be a direction perpendicular to a height direction (e.g., Z-axis direction).

A first connecting terminal 130a to a third connecting terminal 130c may be disposed on the top of a base plate 110. In an embodiment, a first connecting terminal 130a may be disposed on the top of a first external terminal 120a, and a second connecting terminal 130b may be disposed on the top of a second external terminal 120b.

In an embodiment, a third connecting terminal 130c may be spaced apart from a first connecting terminal 130a in a second horizontal direction (e.g., X-axis direction). A second horizontal direction (e.g., X-axis direction) may be a horizontal direction perpendicular to a first horizontal direction (e.g., Y-axis direction).

In an embodiment, a third connecting terminal 130c may be electrically connected to a second electrode tab of a battery cell when a first electrode tab and the second electrode tab of the battery cell protrude in opposite directions. Here, the first electrode tab of the battery cell may be electrically connected to a first connecting terminal 130a.

In an embodiment, a third connecting terminal 130c may move along a second horizontal direction (e.g., X-axis direction). In other words, the distance between a first connecting terminal 130a and a third connecting terminal 130c may be adjusted. Accordingly, a charging or discharging device 100 may be compatible with each of battery cells having various sizes (or lengths).

In an embodiment, a second connecting terminal 130b may be spaced apart from a first connecting terminal 130a in a first horizontal direction (e.g., Y-axis direction).

In an embodiment, a second connecting terminal 130b may be electrically connected to a second electrode tab of a battery cell when a first electrode tab and the second electrode tab of the battery cell protrude in a same direction. Here, the first electrode tab of the battery cell may be electrically connected to a first connecting terminal 130a.

In an embodiment, at least a part of a busbar 140 may be disposed under a base plate 110. Another part of the busbar 140 may be disposed in a through-hole of the base plate 110 and may be in contact with a second external terminal 120b. A through-hole may be formed by penetrating in a height direction (e.g., Z-axis direction) at least a part of an area of a base plate 110 in which a second external terminal 120b is positioned.

In an embodiment, a base plate 110 may include an opening 115. An opening 115 may be formed so that at least a part of an upper portion of a busbar 140 is exposed. In an embodiment, an opening 115 may be positioned in an area between a third connecting terminal 130c and a first connecting terminal 130a.

A rail 150 refers to a track along which a third connecting terminal 130c moves. A third connecting terminal 130c may be movable along a second horizontal direction (e.g., X-axis direction) through a rail 150. In other words, a third connecting terminal 130c may be moved or stopped on a rail 150. In an embodiment, a rail 150 may be disposed along a second horizontal direction (e.g., X-axis direction) from a first connecting terminal 130a. In an embodiment, a rail may be disposed on the top of a base plate 110. In an embodiment, a pair of rails 150 spaced apart in a first horizontal direction (e.g., Y-axis direction) may be disposed on the top of a base plate 110. An opening 115 may be positioned in an area between the pair of rails 150.

In an embodiment, a busbar cover 160 may be disposed between a first connecting terminal 130a and a third connecting terminal 130c. A main body of a battery cell may be mounted on a busbar cover 160.

In an embodiment, a busbar cover 160 may be coupled to a side end of a third connecting terminal 130c. In an embodiment, a busbar cover 160 may be disposed on a rail 150.

In an embodiment, a busbar cover 160 may include a cover member 161 and an accommodating portion 163.

The length of a cover member 161 may be adjusted as a third connecting terminal 130c moves along a second horizontal direction (e.g., X-axis direction). In an embodiment, an end of a cover member 161 may be coupled to a first connecting terminal 130a. An accommodating portion 163 may accommodate at least a part of a cover member 161.

In an embodiment, each of a plurality of connecting terminals 130a to 130c may include at least one of a base frame 131a to 131c, a pressurizing portion 132a to 132c, an adjusting portion 133a to 133c, a slot portion 134a to 134c, and a connecting portion 135a to 135c.

A base frame 131a to 131c may fix a component of each of a plurality of connecting terminals 130a to 130c.

A pressurizing portion 132a to 132c may be disposed at an upper portion of an electrode tab of a battery cell. The height of a pressurizing portion 132a to 132c may be adjusted by an adjusting portion 133a to 133c.

A connecting portion 135a to 135c may be disposed at a lower portion of an electrode tab. A connecting portion 135a to 135c may be electrically connected to a corresponding external terminal among a first external terminal 120a and a second external terminal 120b. Here, the connecting portion 135a to 135c may include a conductive material.

An adjusting portion 133a to 133c may adjust the height of a pressurizing portion 132a to 132c. The height may be a position in the height direction (e.g., Z-axis direction).

An electrode tab of a battery cell may be inserted into a slot portion 134a to 134c. A slot portion 134a to 134c may refer to a space between a pressurizing portion 132a to 132c and a connecting portion 135a to 135c.

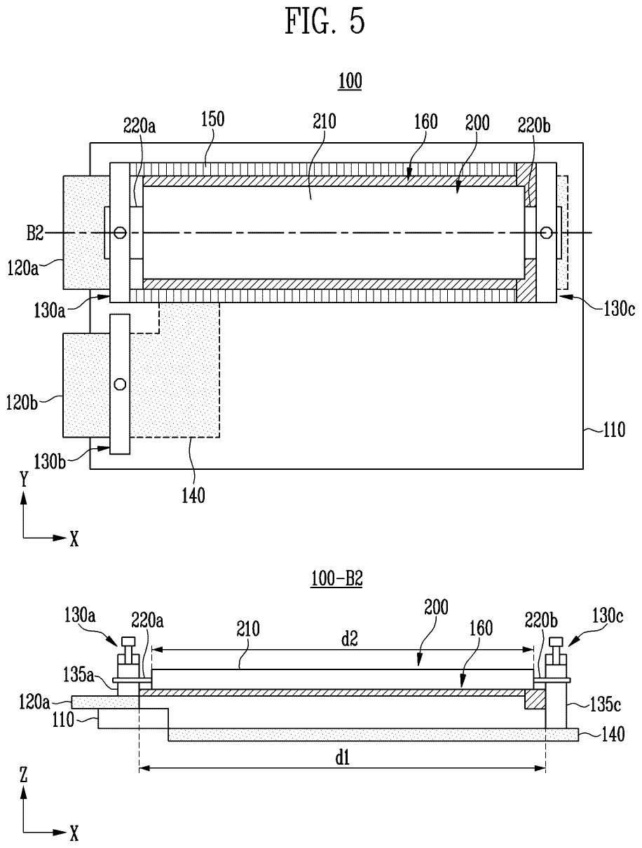

FIG. 5 shows a diagram for explaining a state in which a battery cell of a first type is coupled to a charging or discharging device according to an embodiment. The 100-B2 in FIG. 5 represents a cross-section of B2.

Referring to FIG. 5, a battery cell 200 may include a main body 210 and an electrode tab 220a and 220b. Here, the type of the battery cell 200 may be a first type. A first type may indicate that a pair of electrode tabs 220a and 220b of a battery cell 200 protrude in opposite directions. In an embodiment, electrode tabs 220a and 220b may include a first electrode tab 220a and a second electrode tab 220b protruding in opposite directions from a main body 210. A first electrode tab 220a and a second electrode tab 220b may be electrode tabs having different polarities. A main body 210 may include a cathode, an anode, a separator, and a case accommodating them. In an embodiment, a main body 210 may further include an electrolyte.

A charging or discharging device 100 may include a plurality of external terminals 120a and 120b, a plurality of connecting terminals 130a to 130c, and a busbar 140. In an embodiment, a charging or discharging device 100 may further include at least one of a base plate 110, a rail 150, and a busbar cover 160.

In an embodiment, a busbar cover 160 may be disposed between a first connecting terminal 130a and a third connecting terminal 130c. A main body 210 of a battery cell 200 may be mounted on a busbar cover 160 of a charging or discharging device 100. The busbar cover 160 may minimize the upward exposure of a busbar 140. In other word, a busbar cover 160 may minimize the contact of a battery cell 200 mounted on a charging or discharging device 100 with a busbar 140.

In an embodiment, the distance d1 between a third connecting terminal 130c and a first connecting terminal 130a may be greater than a main body length d2 of a battery cell 200. A main body length d2 may represent the length of a main body 210 of a battery cell 200 in a second horizontal direction (e.g., X-axis direction). The distance d1 between a third connecting terminal 130c and a first connecting terminal 130a may be adjusted as the third connecting terminal 130c moves. The distance d1 between a third connecting terminal 130c and a first connecting terminal 130a may be determined in consideration of a main body length d2 and/or the distance between electrode tabs 220a and 220b of a battery cell 200.

In an embodiment, a first electrode tab 220a of a battery cell 200 may be electrically connected to a first external terminal 120a through a connecting portion 135a of a first connecting terminal 130a. A second electrode tab 220b of a battery cell 200 may be electrically connected to a second external terminal 120b through a connecting portion 135c of a third connecting terminal 130c and a busbar 140.

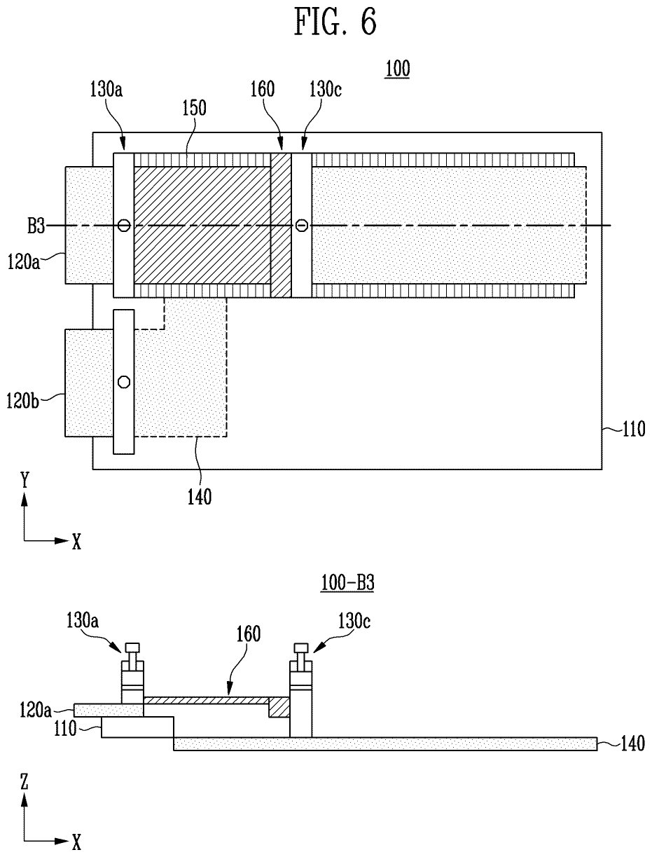

FIG. 6 shows a diagram for explaining a state in which a third connecting terminal has moved according to an embodiment. The 100-B3 in FIG. 6 represents a cross-section of B3.

Referring to FIGS. 5 and 6, a third connecting terminal 130c of a charging or discharging device 100 may move in a second horizontal direction (e.g., X-axis direction) relative to a first connecting terminal 130a.

In an embodiment, a busbar cover 160 may be positioned between a third connecting terminal 130c and a first connecting terminal 130a. In an embodiment, a busbar cover 160 may move together with the a third connecting terminal 130c. In this case, the length of the busbar cover 160 may be adjusted. For example, when the extent to which a cover member 161 is accommodated in an accommodating portion 163 increases, the length of a busbar cover 160 may decrease, and when the extent to which a cover member 161 is accommodated in an accommodating portion 163 decreases, the length of a busbar cover 160 may increase.

In an embodiment, as shown in FIG. 6, a third connecting terminal 130c may move along a second horizontal direction (e.g., X-axis direction) so that the distance d1 from a first connecting terminal 130a decreases. In this case, the length of a busbar cover 160 may decrease.

In an embodiment, unlike FIG. 6, a third connecting terminal 130c may move along a second horizontal direction (e.g., X-axis direction) so that the distance d1 from a first connecting terminal 130a increases. In this case, the length of a busbar cover 160 may increase.

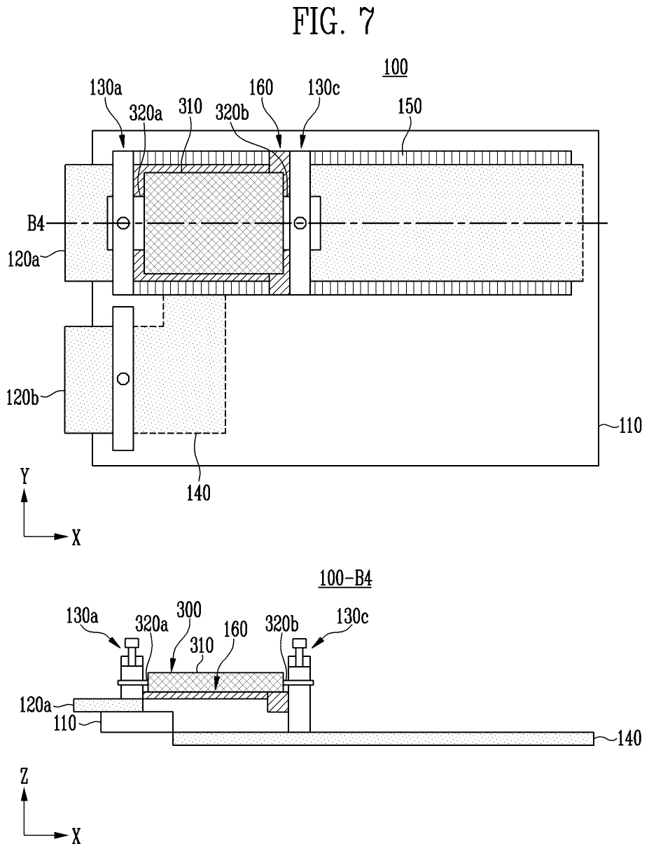

FIG. 7 shows a diagram for explaining a state in which a battery cell of a first type is coupled to a charging or discharging device according to an embodiment. The 100-B4 in FIG. 7 represents a cross-section of B4.

Referring to FIG. 7, a battery cell 300 may include a main body 310 and an electrode tab 320a and 320b. Here, the type of a battery cell 300 may be a first type.

In an embodiment, a busbar cover 160 may be disposed between a first connecting terminal 130a and a third connecting terminal 130c. A main body 310 of a battery cell 300 may be mounted on a busbar cover 160.

In an embodiment, the distance between a third connecting terminal 130c and a first connecting terminal 130a may be greater than the length of a main body of a battery cell 300. The main body length may represent the length of a main body 310 of a battery cell 300 in a second horizontal direction (e.g., X-axis direction).

In an embodiment, a first electrode tab 320a of a battery cell 300 may be electrically connected to a first external terminal 120a through a connecting portion of a first connecting terminal 130a. A second electrode tab 320b of a battery cell 300 may be electrically connected to a second external terminal 120b through a connecting portion of a third connecting terminal 130c and a busbar 140.

Referring to FIGS. 5 and 7, the present disclosure may provide a charging or discharging device 100 compatible with each of battery cells 200 and 300 having various lengths.

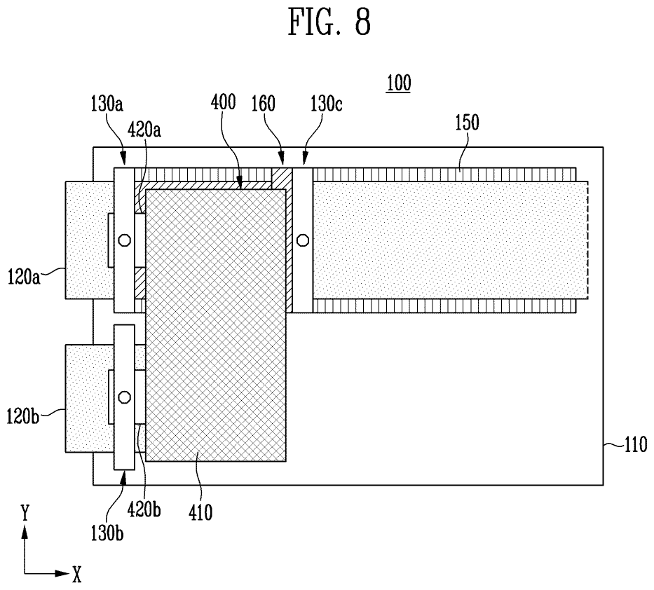

FIG. 8 shows a diagram for explaining a state in which a battery cell of a second type is coupled to a charging or discharging device according to an embodiment.

Referring to FIG. 8, a battery cell 400 may include a main body 410 and an electrode tab 420a and 420b. Here, the type of a battery cell 400 may be a second type. A second type may indicate that a pair of electrode tabs 420a and 420b of a battery cell 400 protrude in a same direction. In an embodiment, electrode tabs 420a and 420b may include a first electrode tab 420a and a second electrode tab 420b protruding in a same direction from a main body 410. A first electrode tab 420a and a second electrode tab 420b may be electrode tabs of different polarities. A main body 410 may include a cathode, an anode, an electrolyte, and a case accommodating them. In an embodiment, a main body 410 may further include an electrolyte.

In an embodiment, a main body 410 of a battery cell 400 may be mounted on at least a part of a busbar cover 160 of a charging or discharging device 100.

In an embodiment, the distance between a third connecting terminal 130c and a first connecting terminal 130a may be greater than a main body length of a battery cell 400. A main body length may represent the length of a main body 410 of a battery cell 400 in a second horizontal direction (e.g., X-axis direction).

In an embodiment, a first electrode tab 420a of a battery cell 400 may be electrically connected to a first external terminal 120a through a connecting portion of a first connecting terminal 130a. A second electrode tab 420b of a battery cell 400 may be electrically connected to a second external terminal 120b through a connecting portion of a second connecting terminal 130b.

As shown in FIGS. 7 and 8, the present disclosure may provide a charging or discharging device 100 compatible with each of various types of battery cells 300 and 400.

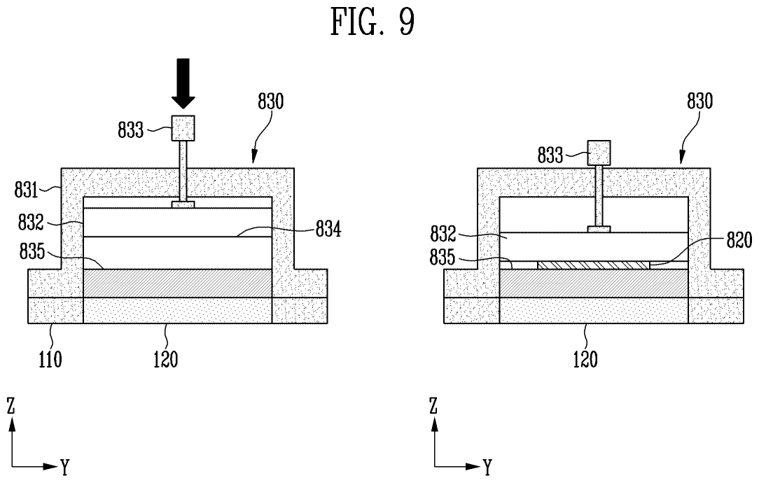

FIG. 9 shows a diagram for explaining a connecting terminal of a charging or discharging device according to an embodiment.

Referring to FIG. 9, a connecting terminal 830 may include a base frame 831, a pressurizing portion 832, an adjusting portion 833, a slot portion 834, and a connecting portion 835. A connecting terminal 830 may be one or each of the above-described first connecting terminal 130a and second connecting terminal 130b.

A base frame 831 may fix a component of a connecting terminal 830. In an embodiment, a base frame 831 may include a lower frame, a connecting frame, and an upper frame. In an embodiment, an adjusting portion 833 may be inserted into a through-hole penetrating an upper frame. A lower frame may be disposed on a base plate 110. An upper frame may be spaced apart from a base plate 110 in a height direction (e.g., Z-axis direction). A connecting frame may connect an upper frame and a lower frame.

A pressurizing portion 832 may be disposed on an upper portion of an electrode tab of a battery cell. The height of a pressurizing portion 832 may be adjusted by an adjusting portion 833. In an embodiment, a pressurizing portion 832 may include a conductive material.

An electrode tab of a battery cell may be inserted into a slot portion 834. A slot portion 834 may refer to a space between a pressurizing portion 832 and a connecting portion 835.

A connecting portion 835 may be electrically connected to an external terminal 120. A connecting portion 835 may include a conductive material. An external terminal 120 may be one or each of a first external terminal 120a and a second external terminal 120b. For example, a lower end of a connecting portion 835 may be in contact with an upper portion of an external terminal 120.

A connecting portion 835 may be disposed at a lower portion of an electrode tab of a battery cell.

An adjusting portion 833 may adjust the height of a pressurizing portion 832. A lower end of a adjusting portion 833 may be in contact with an upper end of a pressurizing portion 832. For example, when an adjusting portion 833 is turned clockwise or counterclockwise, the height of a pressurizing portion 832 may be increased or decreased.

In an embodiment, when an electrode tab of a battery cell is inserted into a slot portion 834, the height of a pressurizing portion 832 may be gradually lowered by an adjusting portion 833. In this case, the pressurizing portion 832 may pressurize an upper portion of the electrode tab of the battery cell so that a lower portion of the electrode tab may be in contact with an upper portion of a connecting portion 835. In this case, the electrode tab of the battery cell may be electrically connected to an external terminal 120 through the connecting portion 835.

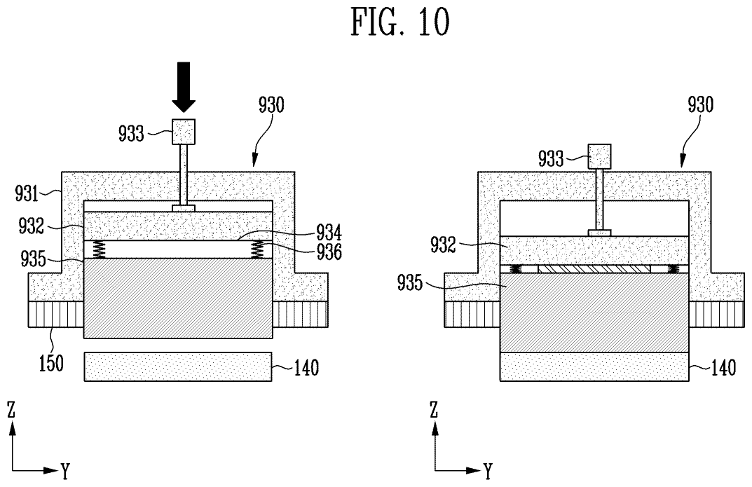

FIG. 10 shows a diagram for explaining a connecting terminal of a charging or discharging device according to an embodiment.

Referring to FIG. 10, a connecting terminal 930 may include a base frame 931, a pressurizing portion 932, an adjusting portion 933, a slot portion 934, and a connecting portion 935. A connecting terminal 930 may be the above-described third connecting terminal 130c. In an embodiment, a connecting terminal 930 may further include an elastic member 936.

A base frame 931 may fix a component of a connecting terminal 930. In an embodiment, a base frame 931 may include a lower frame, a connecting frame, and an upper frame. In an embodiment, an adjusting portion 933 may be inserted into a through-hole penetrating an upper frame. A lower frame may be disposed on a rail 150. An upper frame may be spaced apart in a height direction (e.g., Z-axis direction) from a rail 150 or a base plate 110. A connecting frame may connect an upper frame and a lower frame.

An electrode tab of a battery cell may be inserted into a slot portion 934. A slot portion 934 may refer to a space between a pressurizing portion 932 and a connecting portion 935.

A pressurizing portion 932 may be disposed at an upper portion of an electrode tab of a battery cell. The height of a pressurizing portion 932 may be adjusted by an adjusting portion 933. In an embodiment, a pressurizing portion 932 may include a conductive material.

A connecting portion 935 may be disposed at a lower portion an electrode tab of a battery cell. A connecting portion 935 may include a conductive material. The height of a connecting portion 935 may be adjusted by an adjusting portion 933.

An elastic member 936 may be connected between a pressurizing portion 932 and a connecting portion 935.

An adjusting portion 933 may adjust the height of a pressurizing portion 932. An adjusting portion 933 may adjust the height of a connecting portion 935 through a pressurizing portion 932 and an elastic member 936. A lower end of an adjusting portion 933 may be in contact with an upper end of a pressurizing portion 932. For example, when an adjusting portion 933 is turned clockwise or counterclockwise, the height of a pressurizing portion 932 may be increased or decreased.

In an embodiment, a connecting portion 935 may be in one of a state of being spaced apart from a busbar 140 or in contact with a busbar 140 depending on the adjustment by an adjusting portion 933.

In a specific embodiment, when the height of a pressurizing portion 932 is lowered by an adjusting portion 933, an elastic member 936 may be compressed. The height of a connecting portion 935 is lowered by a compressed elastic member 936, and a connecting portion 935 may be in contact with a busbar 140. In this case, the connecting portion 935 may be electrically connected to the busbar 140. For example, when a connecting terminal 930 is stopped, a connecting portion 935 may be in contact with a busbar 140 by an adjusting portion 933.

In a specific embodiment, when the height of a pressurizing portion 932 is increased by an adjusting portion 933, an elastic member 936 may be tensioned. The height of a connecting portion 935 increases due to the restoring force of a tensioned elastic member 936, and a connecting portion 935 may be separated from a busbar 140. In this case, the electrical connection of the connecting portion 935 with the busbar 140 may be cut off. For example, when a connecting terminal 930 moves along a rail 150, a connecting portion 935 may be separated from a busbar 140 by an adjusting portion 933.

In an embodiment, when an electrode tab of a battery cell is inserted into a slot portion 934, the height of a pressurizing portion 932 may be gradually lowered by an adjusting portion 933. In this case, the pressurizing portion 932 pressurizes an upper portion of the electrode tab of the battery cell, so that a lower portion of the electrode tab may be in contact with an upper portion of a connecting portion 935. In addition, a lower portion of a connecting portion 935 may be in contact with an upper portion of a busbar 140. In this case, an electrode tab of a battery cell may be electrically connected to the busbar 140 through the connecting portion 935.

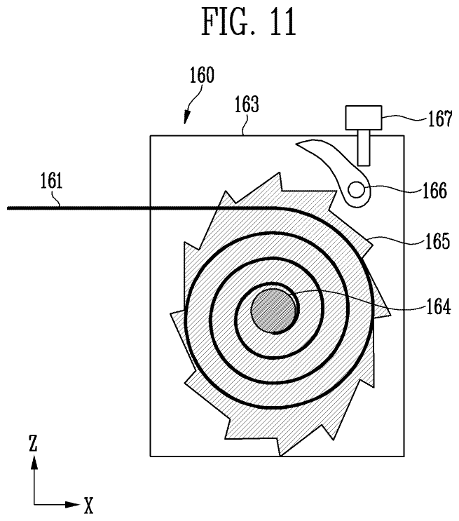

FIG. 11 shows a drawing for explaining a busbar cover of a charging or discharging device according to an embodiment.

Referring to FIG. 11, a busbar cover 160 may include a cover member 161 and an accommodating member 163. One end of a busbar cover 160 may be fixed to a first connecting terminal, and the other end of a busbar cover 160 may be fixed to a third connecting terminal. A first connecting terminal and a third connecting terminal may be spaced apart in a second horizontal direction (e.g., X-axis direction).

At least a part of a cover member 161 may be accommodated in an accommodating member 163, and the remainder of the cover member 161 may protrude from the accommodating member 163. At least a part of a cover member 161 may protrude along a second horizontal direction (e.g., X-axis direction). A protruding end of a cover member 161 may be fixed to a first connecting terminal.

An accommodating member 163 may include at least one of a rotating shaft 164, a latch 165, a lever 166, a switch 167, and a case. At least a part of a cover member 161, a rotating shaft 164, a latch 165, a lever 166, and at least a part of a switch 167 may be accommodated inside a case.

A rotating shaft 164 may wind or unwind a cover member 161. In an embodiment, a rotating shaft 164 may wind or unwind a cover member 161 as it rotates clockwise or counterclockwise. The other end of a cover member 161 may be fixed to a rotating shaft 164. When a rotating shaft 164 winds a cover member 161, the extent to which the cover member 161 is accommodated inside a case may increase. When a rotation shaft 164 unwinds a cover member 161, the extent to which the cover member 161 is accommodated inside a case may be decreased.

A latch 165 may be coupled to a rotating shaft 164. A latch 165 may rotate together with a rotating shaft 164. A latch 165 may have a gear shape, but is not limited thereto and may be formed in various shapes.

A lever 166 may prevent the rotation of a latch 165 in ae direction in which a cover member 161 is wound, either clockwise or counterclockwise. A lever 166 may be rotated in only one direction due to the interference of a latch 165.

A switch 167 may separate a lever 166 from a latch 165. In this case, the interference of the latch 165 is nullified, so that a cover member 161 may be wound.

Meanwhile, the structure of the above-described accommodating portion 163 is only an example, and may be implemented in various ways.

In an embodiment, an accommodating portion (163) may include a spring member, a lever (166), and a switch (167).

A spring member may be coupled to one end of a cover member (161). For example, one end of a cover member (161) may be an end that is different from the one fixed to a first connecting terminal among the two ends of the cover member. A spring member may wind the cover member by a restoring force when a cover member is unwound. For example, a spring member may be made of an elastic material and May have a spiral shape. The length of a spring member may increase when a cover member (161) is unwound, and may wind the cover member (161) by the restoring force.

A lever (166) may be in contact with a cover member (161). A lever (166) may prevent the winding of a cover member. For example, a lever (166) may prevent the winding of a cover member (161) by a frictional force with the cover member.

A switch may separate a lever (166) from a cover member (161) so that the cover member (161) is wound by a spring member.

What is claimed is:

1. A charging or discharging device comprising:
a plurality of external terminals including a first external terminal and a second external terminal for charging or discharging a battery cell;
a first connecting terminal electrically connected to the first external terminal;
a busbar electrically connected to the second external terminal;
a second connecting terminal spaced apart from the first connecting terminal in a first horizontal direction and electrically connected to the second external terminal; and
a third connecting terminal spaced apart from the first connecting terminal in a second horizontal direction perpendicular to the first horizontal direction and electrically connected to the second external terminal through the busbar.

2. The charging or discharging device according to claim 1, wherein the first connecting terminal is electrically connected to a first electrode tab of the battery cell, and one of the second connecting terminal or the third connecting terminal is electrically connected to a second electrode tab of the battery cell.

3. The charging or discharging device according to claim 2, wherein the second connecting terminal is electrically connected to the second electrode tab when the first electrode tab and the second electrode tab protrude in a same direction.

4. The charging or discharging device according to claim 2, wherein the third connecting terminal is electrically connected to the second electrode tab when the first electrode tab and the second electrode tab protrude in opposite directions.

5. The charging or discharging device according to claim 1, further comprising: a rail disposed under the third connecting terminal, wherein the third connecting terminal is movable along the second horizontal direction through the rail.

6. The charging or discharging device according to claim 5, wherein the distance between the third connecting terminal and the first connecting terminal is longer than the length of a main body of the battery cell.

7. The charging or discharging device according to claim 1, further comprising: a base plate disposed under the plurality of external terminals, the first connecting terminal, the second connecting terminal, and the third connecting terminal, wherein at least a part of the busbar is disposed under the base plate.

8. The charging or discharging device according to claim 7, wherein the base plate includes an opening formed so that at least a part of an upper portion of the busbar is exposed, and the opening is positioned in an area between the third connecting terminal and the first connecting terminal.

9. The charging or discharging device according to claim 8, further comprising: a busbar cover which is disposed between the first connecting terminal and the third connecting terminal and on which the main body of the battery cell is mounted.

10. The charging or discharging device according to claim 9, wherein the busbar cover includes: a cover member of which length is adjusted as the third connecting terminal moves along the second horizontal direction; and an accommodating portion in which at least a part of the cover member is accommodated.

11. The charging or discharging device according to claim 10, wherein the accommodating portion includes:
a rotating shaft winding or unwinding the cover member;
a latch coupled to the rotating shaft;
a lever preventing rotation of the latch in a direction in which the cover member is wound, either clockwise or counterclockwise; and
a switch separating the lever from the latch so that the cover member is wound.

12. The charging or discharging device according to claim 10, wherein the accommodating portion includes:
a spring member coupled to one end of the cover member and winding the cover member by a restoring force when the cover member is unwound;
a lever being in contact with the cover member and preventing the winding of the cover member; and
a switch separating the lever from the cover member so that the cover member is wound by the spring member.

13. The charging or discharging device according to claim 1, wherein at least one of the first connecting terminal or the second connecting terminal includes:
a pressurizing portion disposed at an upper portion of a corresponding electrode tab among a first electrode tab and a second electrode tab of the battery cell protruding in a same direction;
a connecting portion disposed at a lower portion of the corresponding electrode tab and electrically connected to a corresponding external terminal among the first external terminal and the second external terminal; and
an adjusting portion adjusting the height of the pressurizing portion so that the pressurizing portion pressurizes the upper portion of the corresponding electrode tab so that the corresponding electrode tab is electrically connected to the connecting portion.

14. The charging or discharging device according to claim 1, wherein the third connecting terminal includes:
a pressurizing portion disposed at an upper portion of a second electrode tab among a first electrode tab and a second electrode tab of the battery cell protruding in opposite directions;
a connecting portion disposed at a lower portion of the second electrode tab; and
an adjusting portion adjusting the height of the pressurizing portion so that the pressurizing portion pressurizes the upper portion of the second electrode tab to electrically connect the second electrode tab to the busbar through the connecting portion.

15. The charging or discharging device according to claim 14, wherein the third connecting terminal further includes an elastic member connected between the pressurizing portion and the connecting portion.

16. The charging or discharging device according to claim 14, wherein the connecting portion is in one of a state of being spaced apart from the busbar or a state of being in contact with the busbar depending on adjustment by the adjusting portion.
